(19) United States
(12) Patent Application Publication
(10) Pub. No.: US 2001/0025400 A1
(43) Pub. Date: Oct. 4, 2001

(54) Passenger chair and safety belt system for such a chair

(76) Inventors: Jens Romca, Kiel (DE); Jochen Mueller, Kiel (DE); Markus Schumacher, Buxtehude (DE)

Correspondence Address: FASSE PATENT ATTORNEYS, P.A., P.O. BOX 726, HAMPDEN, ME, 04444-0726, US

(21) Appl. No.: 09/804,547

(22) Filed: Mar. 9, 2001

(30) Foreign Application Priority Data
Mar. 9, 2000 (DE) 100 11 424.5
Oct. 24, 2000 (DE) 100 52 595.4

(51) Int. Cl. F16G 3/00

(52) U.S. Cl. 24/31 R

(57) ABSTRACT

A safety belt system especially for a passenger chair has at least one, preferably two, safety components each of which includes a controlled flexibility. The controlled flexibility is provided by a relatively stiff sheath or whip or belt section. A limp belt member passes through the sheath with the controlled flexibility. In a second embodiment, the controlled rigidity is provided by a flexible belt end section. In both embodiments one end of each safety component is secured to the chair and the other end has a belt lock element for closing the belt system for use. In an open rest position at least one, preferably both, safety components rest against the backrest of the chair. The controlled flexibility provides a spring biasing force that keeps the safety component in the rest position from which the passenger can turn the safety component into a use position and close the system with one hand.

### PRIORITY CLAIM

This application is based on and claims the priority under 35 U.S.C. §119 of German Patent Applications 100 11 424.5, filed on Mar. 9, 2000 and 100 52 595.4, filed on Oct. 24, 2000, the entire disclosures of which are incorporated herein by reference.

### FIELD OF THE INVENTION

The invention relates to a safety belt system particularly for passenger chairs, specifically aircraft passenger chairs, and to such chairs equipped with the safety belt system. These chairs include a chair support, a seat and a backrest and frequently also armrests.

### BACKGROUND INFORMATION

Passenger seats currently used in commercial aircraft are equipped with safety belts constructed as so-called static belts. The belts are limp and therefore hard to handle. Further, conventional aircraft seat belts are so-called lap belts encircling the lower abdomen of a passenger when the belt lock elements are interlocked. The two belt elements of a passenger chair not in use are normally laid out on the seat surface or somewhere hidden between the seats or between a window seat and the cabin wall. Both situations are interfering with a passenger's attempt to quickly sit down in his assigned seat because the passenger must first separate the belt ends before he can sit down or he can sit down on the belt ends and then try to “fish” the belt ends out. Similarly, when the belt ends are hidden, time consuming efforts must be made to find the belt ends. Further, the time required for cleaning an aircraft cabin on the ground and making the aircraft ready for the next flight is prolonged if the belt ends for each seat must be positioned in a crossed-over fashion on each seat. This part of the cabin preparation for the next flight is rather time consuming, particularly where a large number of passenger seat belts are involved in a jumbo aircraft. A prolonged time for cabin cleaning and cabin preparation is undesirable because it increases the ground time of the aircraft between flights. Similarly, slow boarding because passengers are trying to find their seat belts adds to the ground time. The total ground time is a significant factor in the profitability of an aircraft.

### OBJECTS OF THE INVENTION

In view of the above it is the aim of the invention to achieve the following objects singly or in combination:

to provide a safety belt system for a passenger chair and a chair equipped with such a system, particularly for a passenger aircraft in which the safety belt system is constructed in such a way that the above outlined disadvantages of conventional seatbelts are avoided;

to reduce the effort and expense for the preparation of an aircraft cabin for the next flight of a passenger aircraft, more specifically to reduce the ground time of an aircraft;

to make it easier for an aircraft passenger to settle in his seat and close the seatbelt without the need for either first removing the belts from the seat or to search for the belt ends, and to avoid that a passenger must use both hands for locking his seat belt; and

to maintain both safety components of the belt system in a defined rest position when the belt components are not used.

### SUMMARY OF THE INVENTION

The above objects have been achieved according to the invention by a safety belt system for a passenger chair, particularly an aircraft passenger chair, in which at least one safety component of two required safety components has a controlled flexibility which provides a biasing force such that the safety component such as a belt member is capable of assuming a straight configuration when in a defined rest position in which the seat belt system is open and to assume a flexible curved configuration when the seat belt system is closed to hold a passenger.

In another embodiment the required controlled flexibility is provided by a sheath that has the required stiffness in the rest position and the required flexibility in the use position, whereby the respective safety belt member is slideably guided within and through the sheath having the controlled flexibility. The belt or the sheath is secured to the chair, specifically to either the seat or to the backrest, in such a way that the sheath or a stiff but inherently flexible section of the belt can rest laterally against the backrest and so that the stiff sheath or stiff belt section may be tilted forwardly from between the backrests for use by a passenger seated in the chair to form a lap belt system.

It is a special advantage of the invention that a passenger, particularly an aircraft passenger, no longer needs to perform the cumbersome and time consuming motions that are required to close a conventional seat belt with two hands. It is no longer necessary to first remove the seat belt sections from the surface of the passenger seat and to use both hands for the closing of the belt lock elements. Thus, a passenger using the new system can be seated more quickly which reduces the overall boarding time, making the operation of the aircraft more profitable. Furthermore, the required cabin preparation time has been reduced because the controlled flexibility according to the invention of the sheath or the belt section may be such that a passenger while opening his safety belt system, can push the stiff sheath or stiff belt section into the space provided for this purpose in the backrest.

### BRIEF DESCRIPTION OF THE DRAWINGS

In order that the invention may be clearly understood, it will now be described in connection with an example embodiment, with reference to the accompanying drawings, wherein:

FIG. 1 is a perspective view of a first embodiment of a passenger chair with a safety belt system according to the invention having two sheaths each with a controlled flexibility for holding the limp belt members upright in a rest position, wherein each belt member is taken up by a belt roll-up mechanism;

FIG. 2 shows a perspective view of a second embodiment of the present safety belt system with two sheaths having the controlled flexibility, but using only one belt roll-up mechanism directly secured to one of the sheaths;

FIG. 3 is a view similar to FIG. 1, but illustrating a modified embodiment according to the invention with only one sheath having the required controlled flexibility.

### DETAILED DESCRIPTION OF PREFERRED EXAMPLE EMBODIMENTS AND OF THE BEST MODE OF THE INVENTION

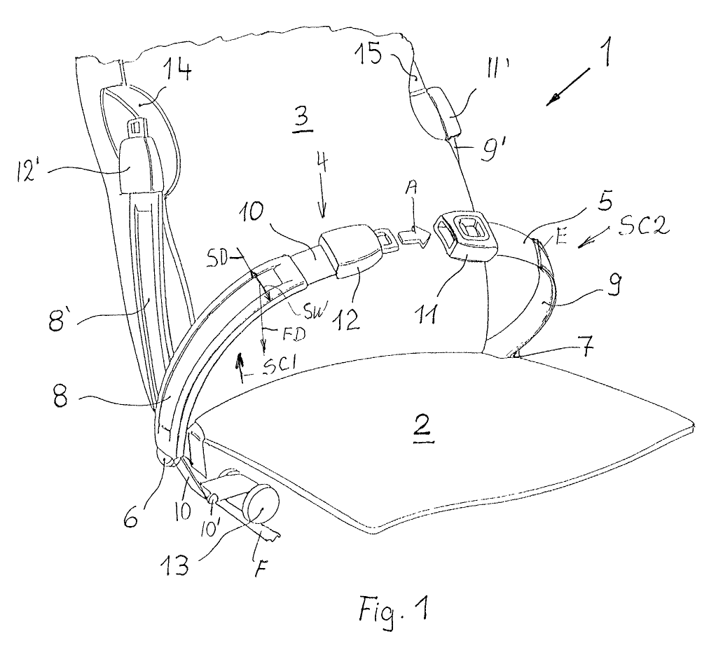

FIG. 1 shows a passenger chair 1 equipped with a safety belt system 4 for use, for example, in an aircraft passenger cabin. The chair comprises a seat 2 and a backrest 3 supported or mounted on a frame F. The system 4 comprises a first safety component SC1 and a second safety component SC2. The first safety component SC1 comprises a first sheath 8 having a controlled flexibility, a first lap belt member 10 guided in the sheath 8, and a lock element 12 secured to a free end of the belt member 10. The first safety component SC1 further includes a conventional belt roll-up mechanism 13, preferably mounted to the frame F or to the seat 2 in a recessed position. A pivot or journal 6 connects the lower end of the sheath 8 to the chair, preferably to the lower end of the backrest 3. A guide roller 10′ is mounted in such a position that it will properly guide the belt member 10 into the sheath 8.

When the belt member 10 is fully rolled-up so that the lock element 12 bears against a free end of the sheath 8, the first safety component SC1 can be brought into a rest position 12′, whereby the lock element 12 rests in a recess 14 of the backrest 3 and the sheath 8 also assumes a rest position 8′ alongside the backrest. Due to the controlled flexibility of the sheath 8 it has an inherent biasing force that will keep the sheath and the lock element 12 in the respective rest positions 8′ and 12′.

The second safety component SC2 of the belt system 4 comprises a second lock element 11 secured to a free end of a second belt member 5 guided in a sheath 9 having a controlled flexibility. The second safety component SC2 is journalled or pivoted at 7 to the seat 1, preferably to the backrest. When the second belt member 5 is fully rolled-up by its roll-up mechanism, not shown, the lock element 11 bears against and edge E of the sheath 9. In this condition the sheath 9 can be tilted up to assume its rest position 9′ alongside the backrest 3, whereby the second lock element 11 assumes its rest position 11′ in a recess 15 of the backrest 3.

The term “controlled flexibility” of the sheaths 8, 9 or of a safety belt end section will now be described with reference to FIG. 1. Each sheath 8, 9 or belt section has a width SW in the stiff direction SD and is relatively flexible in the flexible direction FD. The sheath or belt section can be produced of synthetic materials and/or fiber composite materials which have the required flexible and spring characteristics so that each sheath is relatively stiff in the stiff direction SD and relatively flexible in the flexible direction FD. When the sheath or belt section is straightened to be brought into the rest position 8′, 9′, the flexibility provides a certain biasing force that tends to keep the sheath or belt section and respective lock element in the upright rest position where the respective lock element can be easily grasped by a passenger for rotating the sheaths with their belts or the belt sections into a position in front of the passenger for interlocking as indicated by the arrow A. The controlled flexibility is sufficient for the present purposes if the biasing force inherent in the sheath or belt section holds the sheath or belt section in the rest position 8′, 9′. The belt end section is the belt end to which the respective lock element is connected. The remainder of the belt remains limp while the belt end section has the controlled flexibility.

The automatic roll-up mechanism 13 is of conventional construction and permits lengthening the respective first and second belt member 10 and/or 5 to the proper length. The passenger no longer is required to pull one belt end through a locking element until the belt is sufficiently tight following the interlocking as is necessary in conventional aircraft seat safety belts.

The above mentioned controlled flexibility of the sheaths 8 and 9 or belt end sections is preferably so selected that a biasing force is also tending to bring the respective sheath automatically into the rest position alongside the backrest 3. The size and position of the recess 14, 15 for holding the respective lock element 12, 11 is so selected that a passenger can grasp the respective lock element after sitting down, for turning the respective sheath or belt end into the use position. Once both sheaths 8, 9 or belt ends are tilted or turned into the use position the belt member 10 and/or the belt member 5 are released from their respective roll-up mechanism to a sufficient extent for the inter-locking of the lock elements 11, 12 to close the lock and thus the belt system around a passenger.

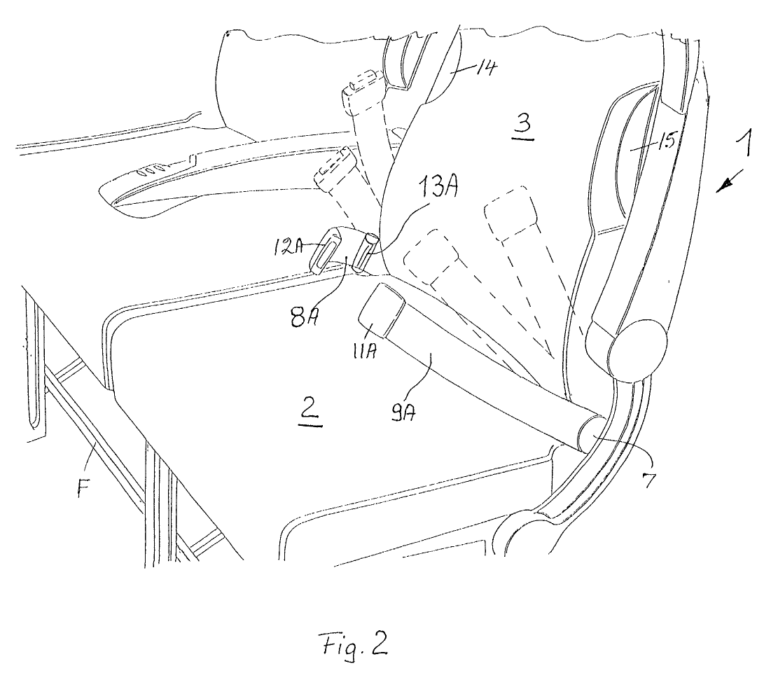

FIG. 2 shows a second embodiment, wherein a roll-up mechanism 13A for the belt member 10 is attached to a sheath 8A. As shown the belt member is fully recessed in the roll-up mechanism 13A. A belt end section 9A is formed in this embodiment to have the required controlled flexibility to replace the flexible sheath 9 of FIG. 1. A journal 7 connects the belt end section 9A to the lower end of the backrest 3. The belt end section 9A does not guide any belt member. Rather, the belt end section 9A may be a piece of material that has the above described controlled flexibility. The lock element 11A is directly connected to the free end of the belt end section 9A. Both the sheath 8A and the belt end section 9A can be rotated into the rest position as shown by dashed lines so that the lock element 12A will rest in the recess 14 and the lock element 11A will rest in the recess 15. The embodiment of FIG. 2 has the advantage that it requires fewer components and can hence be constructed more compact. For example, only one roll-up mechanism 13A is required. If maintenance work is to be performed, the journals 6 and 7 are easily released for exchanging one or the other or both safety components.

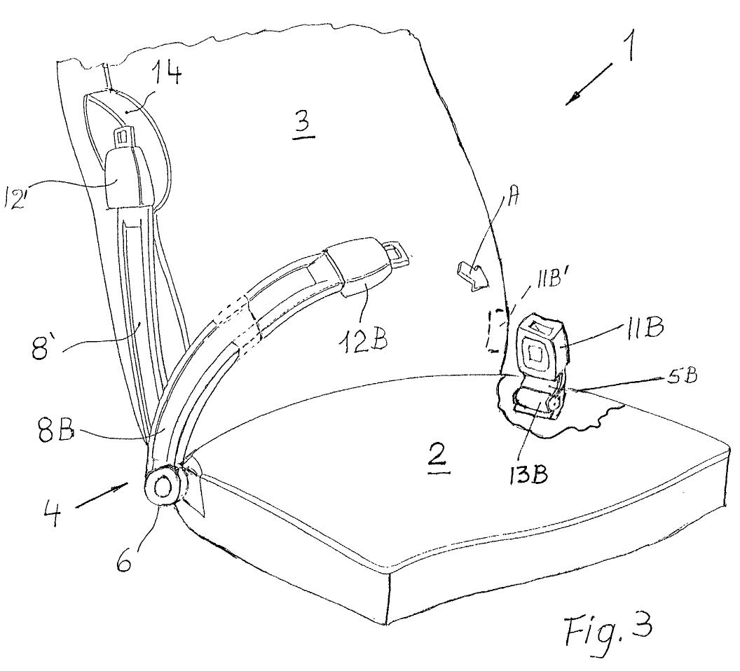

FIG. 3 illustrates an embodiment in which the safety belt system 4 comprises a flexible whip 8B having secured a lock element 12B to its free end. The other end of the whip 8B having the required controlled flexibility is hinged by a journal 6 to either the frame or the seat 2 or the backrest 3. On the opposite side of the chair a lock element 11B with a belt member 5B cooperates with an automatic roll-up mechanism 13B that may be mounted in the seat 2 as shown in full lines or in the backrest in a rest position 11B′ as shown in dashed lines. In the preferred embodiment a recess for holding the lock element 11B in the rest position 11B′ is provided in the backrest 3 at a level corresponding to the pelvis of a passenger. The recess for the lock element 11B is also sufficiently large for grasping. Only one retractable belt member is necessary in the embodiment of FIG. 3. That single belt member can be secured to the lock element 11B as shown or it may be guided in the sheath or whip 8B as shown at 8A in FIG. 2.

In all embodiments of the invention it is possible to close the safety belt system with one hand without pulling a belt end through a lock element. Similarly, opening the belt system can be done by one hand. The belt lock elements 11 and 12 or 11A and 12A or 11B and 12B are so held in the rest position by the sheaths or belt end sections that the belt lock elements cannot spring back out of the respective recesses 14, 15, 11B′ and cannot assume an uncontrolled position because the controlled flexibility and respective biasing force assures a defined rest position of the lock elements.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A safety seat belt system for a passenger chair, said safety belt system comprising a first safety component (SC1) and a second safety component (SC2) cooperating with said first safety component for providing a safety belt function, said first safety component including a first belt device (8,8A, 8B) having a controlled flexibility providing a biasing force such that said first belt device is capable of assuming a straight configuration when in a rest position (8′) and a flexible curved configuration when in a use position, said first safety component further comprising a first belt lock element (12, 12A, 12B) secured to a free end of said first belt device, and wherein said second safety component (SC2) comprises at least a second belt lock element (11, 11A, 11B) secured in a position for cooperation with said first belt lock element (12, 12A, 12B) for interlocking said first safety component with said second safety component to close the safety belt system.

2. The safety seat belt system of claim 1, wherein said first belt device of said first safety component comprises a flexible sheath (8, 8A) and a seat belt member (10) guided in said flexible sheath, and wherein said flexible sheath has said controlled flexibility.

3. The safety seat belt system of claim 2, wherein said flexible sheath is made of a flexible material which has an inherent stiffness, and wherein said flexible sheath has a given width (W) in a stiff direction (SD) in which said sheath is resistant against bending, and a given thickness in a flexible direction (FD) in which said sheath is flexible for fitting around a passenger's body.

4. The safety seat belt system of claim 2, further comprising a belt roll-up mechanism (13A) secured in or on said flexible sheath.

5. The safety seat belt system of claim 2, further comprising a belt roll-up mechanism (13), and wherein a length portion of said first belt member (10) is sufficiently flexible for roll-up by said roll-up mechanism.

6. A passenger chair comprising a chair support (F), a seat (2) mounted on said chair support, a backrest (3) supported by said chair support, a safety seat belt system as part of said passenger chair, said safety seat belt system comprising a first safety component (SC1) and a second safety component (SC2) cooperating with said first safety component for providing a safety belt function, said first safety component including a first belt device having a controlled flexibility providing a biasing force such that said first belt device is capable of assuming a straight configuration when in a rest position and a flexible curved configuration when in a use position, said first safety component further comprising a first belt lock element secured to a free end of said first belt device, and wherein said second safety component comprises at least a second belt lock element secured in a position for cooperation with said first belt lock element for interlocking said first safety component with said second safety component in said use position.

7. The passenger chair of claim 6, wherein said first belt device of said first safety component comprises a flexible sheath and a seat belt member held in said flexible sheath, and wherein said flexible sheath has said controlled flexibility.

8. The passenger chair of claim 7, wherein said flexible sheath is made of a flexible material which has an inherent stiffness, and wherein said sheath has a given width in a stiff direction in which said sheath is resistant against bending and a given thickness in a flexible direction in which said sheath is flexible for fitting around a passenger's body.

9. The passenger chair of claim 7, further comprising a belt roll-up mechanism secured in or on said flexible sheath.

10. The passenger chair of claim 6, further comprising a belt roll-up mechanism, and wherein a length portion of said first belt member is sufficiently flexible for roll-up by said roll-up mechanism.

11. The passenger chair of claim 6, wherein said roll-up mechanism is arranged on or in said seat (2).

12. The passenger chair of claim 6, wherein said backrest comprises a recess (14, 15) along at least one of its sides for storing a respective belt lock element, in said rest position.

13. The passenger chair of claim 12, wherein said recess is formed in said backrest at a level above said seat section.

14. The passenger chair of claim 6, further comprising a first journal mounting (6) securing an end of said first safety component to said backrest (3) and a second journal mounting (7) securing said second safety component to said backrest (3).

15. The passenger chair of claim 14, wherein said first and second journal mountings are pivot mountings.

16. The passenger chair of claim 6, wherein said second safety component comprises a second belt device (9A) also having a controlled flexibility.

17. The passenger chair of claim 16, further comprising a flexible sheath for each of said first and second belt devices, wherein each flexible sheath provides said controlled flexibility.
